(19) United States
(12) Patent Application Publication
(10) Pub. No.: US 2003/0024332 A1
(43) Pub. Date: Feb. 6, 2003

(54) Sensor connector assembly

(75) Inventors: Michael J. Traphagen, Amherst, NY (US); Dan Corneliu Cilibia, Dusseldorf (DE); Duane Brzezowski, Blasdell, NY (US)

Correspondence Address: Robert P. Simpson, Esq., Simpson, Simpson & Snyder, PLLC, 5555 Main Street, Williamsville, NY, 14221-5406, US

(73) Assignee: PCB Piezotronics Inc., IMI Sensors, Depew, NY (US)

(21) Appl. No.: 09/920,216

(22) Filed: Aug. 1, 2001

(51) Int. Cl. G01D 21/00; G01P 1/02

(52) U.S. Cl. 73/866.5; 73/493

(57) ABSTRACT

A sensor connector assembly having a lower housing having a base operatively arranged to hold the sensor, and an integral male upper threaded section having a terminal block fixedly secured therein, an upper housing having a female lower threaded section operatively arranged to threadably engage the integral male upper threaded section of the lower housing, the upper housing also having an integral male upper threaded section having an aperture therein to pass a cable for the sensor, and, a sealing nut having a female threaded section operatively arranged to threadably engage the integral male upper threaded section of the upper housing and also having an aperture therein to pass the cable for the sensor.

### FIELD OF THE INVENTION

The invention relates generally to sensors and, more particularly, to a new sensor connector assembly.

### BACKGROUND OF THE INVENTION

Sensors measure virtually anything that moves, shakes, or vibrates. From the subtleties of chameleon communications to the shattering blasts of a space shuttle launch, sensors such as accelerometers provide accurate measurements in an astonishing diversity of applications and operating environments. While the connector assembly of the present invention is intended to be suitable for use with a wide variety of sensors, for purposes of illustration and to illustrate the best mode of practicing the invention, reference is made herein to piezoelectric accelerometer type sensors.

Accelerometers are transducers or sensors which convert the acceleration aspect of motion into an electrical signal for measurement, monitoring and control purposes. Typical applications for this type of accelerometer include machinery vibration, environmental stress screening, vibration control, modal analysis and structural testing, seismic vibration, package testing and shock sensing.

Piezoelectric accelerometers utilize the piezoelectric effect of quartz and special polycrystalline ceramics to generate an electrical signal proportional to the vibration or shock. The piezoelectric effect produces an opposed accumulation of charged particles on the crystal. This charge is proportional to applied force or stress. A force applied to a quartz crystal lattice structure alters alignment of positive and negative ions, which results in an accumulation of these charged ions on opposed surfaces. These charged ions accumulate on an electrode, where it is ultimately conditioned by transistor microelectronics.

In an accelerometer, the stress on the crystals occurs as a result of the seismic mass imposing a force on the crystal. Over its specified frequency range, this structure approximately obeys Newton's law of motion, F=ma. Therefore, the total amount of accumulated charge is proportional to the applied force, and the applied force is proportional to acceleration. Electrodes collect and wires transmit the charge to a signal conditioner which may be remote or built into the accelerometer. Sensors containing built-in signal conditioners are classified as ICP or voltage mode, whereas, those utilizing remote signal conditioners are called charge mode. Once the charge is conditioned by the signal conditioning electronics, the signal is available for display, recording, analysis or control purposes.

Piezoelectric accelerometers can be broken down into two categories which define their mode of operation. Internally amplified, ICP accelerometers contain built-in microelectronics signal conditioning. Charge mode accelerometers contain only the sensing element with no electronics. In either case, standard coaxial cables, or twisted pair wires, are used to transmit the signals from the accelerometer to either a voltage readout or recording device (in the case of an ICP accelerometer), or a signal conditioner.

Cables should be securely fastened to the mounting structure with a clamp, tape or other adhesive to minimize cable whip and connector strain. Cable whip can introduce noise, especially in high impedance signal paths. This phenomena is known as the triboelectric effect. Also, cable strain near the electrical connector can often lead to intermittent or broken connections and loss of data. To prevent this problem, it is important to securely fasten excess cable length to eliminate the possibility of cable whip. Coaxial cables are normally provided in predetermined lengths, with appropriate conventional connectors on both ends. For example, well-known coaxial connectors include coaxial plugs and BNC plugs. A problem with using predetermined lengths of cable is that it is cumbersome for a user to have to measure the required cable length and then order the correct length cable from a manufacturer. If the cable length is too short, the sensor can't be used. If the cable length is too long, one has to be concerned with cable whip. Also, the coaxial connectors are relatively expensive.

Some prior art connectors include solder connector adaptors that accommodate soldering of twisted pair or pigtail wires to connection pins. These solder connector adaptors provide a more durable connection and can be installed onto the accelerometer with a thread locking compound to prevent loosening. These connectors are typically used in high shock conditions or when cables must undergo large amounts of motion, as with package drop testing applications. This type of connection is known to be user or field repairable in times of crisis. Unfortunately, presently a flexible vinyl cap is placed over the electrical connection for protection purposes and to provide cable strain relief. The cable is then routed downwardly along the outer surface of the housing, and often taped to the accelerometer housing. This routing of the cable is somewhat awkward, and it is somewhat difficult to seal the connection to protect against potential moisture and dirt contamination. Moreover, prior art solder connectors typically comprise a modified coaxial plug.

What is needed, then, is a new type of connector assembly for a sensor that permits users to inventory and cut cable to length as needed, rather than buying predetermined lengths of cable from manufacturers or distributors, and also provides a simple, user or field repairable connection as well as a connection which offers a seal to protect against moisture and dirt contamination.

### SUMMARY OF THE INVENTION

A sensor connector assembly having a lower housing having a base operatively arranged to hold the sensor, and an integral male upper threaded section having a terminal block fixedly secured therein, an upper housing having a female lower threaded section operatively arranged to threadably engage the integral male upper threaded section of the lower housing, the upper housing also having an integral male upper threaded section having an aperture therein to pass a cable for the sensor, and, a sealing nut having a female threaded section operatively arranged to threadably engage the integral male upper threaded section of the upper housing and also having an aperture therein to pass the cable for the sensor.

A general object of the present invention is to provide an improved sensor connector assembly that obviates coaxial cable plugs and connectors.

A secondary object of the present invention is to provide an improved sensor connector assembly that permits users of the sensor to make connections and repairs in the field or on site, without need to purchase predetermined lengths of cable from a manufacturer or distributor.

Another object of the present invention is to provide an improved sensor connector assembly that features a solderless terminal block to facilitate quick and easy connection of terminal leads.

These and other objects, features and advantages of the present invention will become readily apparent upon a reading of the following detailed description in view of the drawings and appended claims.

### BRIEF DESCRIPTION OF THE DRAWINGS

FIG. 1 illustrates a first type of prior art sensor connector assembly;

FIG. 2 illustrates a second type of prior art sensor connector assembly;

FIG. 3 is a side view of the sensor connector assembly of the present invention;

FIG. 4 is an exploded view of the sensor connector assembly of the present invention;

FIG. 5 is a top view taken generally along line 5-5 in FIG. 4;

FIG. 6 is a view of the lower housing of the present invention, illustrating the connection of the cable leads to the terminal block;

FIG. 7 is a partial cut-away view of the terminal block and lower housing, taken generally along line 7-7 of FIG. 6; and,

FIG. 8 is a view of the connector assembly of the present invention, shown with the cable completely connected and assembled.

### DETAILED DESCRIPTION OF THE PREFERRED EMBODIMENT

It should be appreciated at the outset that identical reference numbers on different drawing views refer to identical structural elements. It should also be appreciated that, although a piezoelectric accelerometer is depicted in the drawings and described in the specification to illustrate the invention, the claims are directed to a sensor connector assembly generally, and are not intended to be limited to piezoelectric accelerometer sensors.

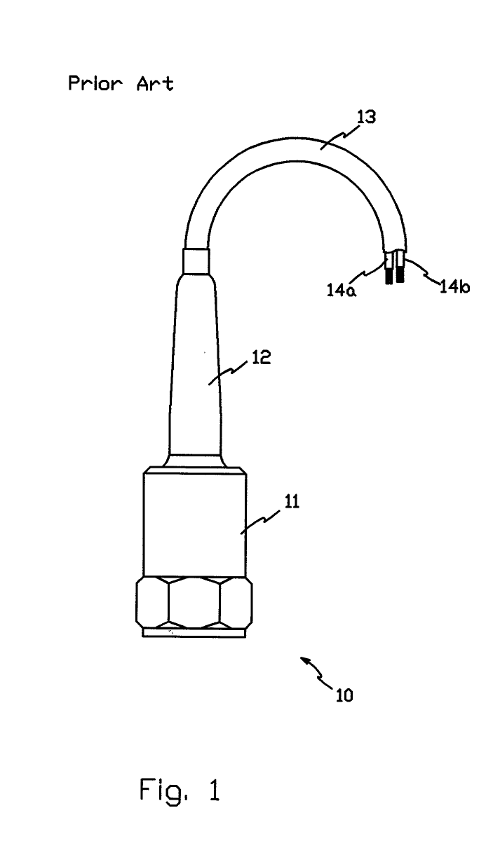

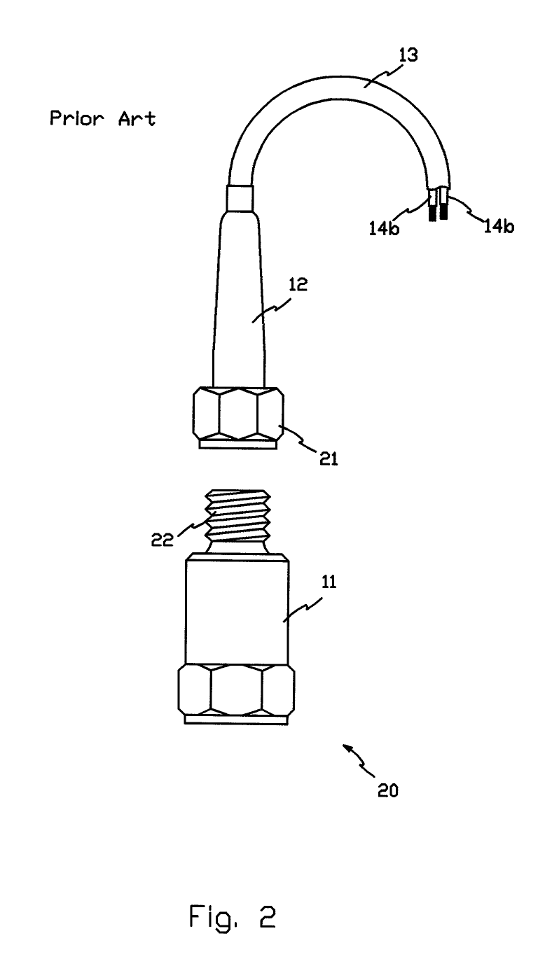

Adverting now to the drawings, FIGS. 1 and 2 both illustrate different types of sensor connector assemblies known in the art. As shown in FIG. 1, sensor assembly 10 broadly comprises sensor housing 11, cable 12 joined to the sensor housing 11 by molded shielded cable segment 12, where the cable includes leads 14a and 14b. In this prior art embodiment, the leads are hard-wired into the sensor housing, and the unit is not easily repairable or serviceable in the field. FIG. 2 illustrates another prior art embodiment. Sensor assembly 11 is shown to broadly comprise sensor housing 11 which includes upper threaded section 22. Cable 13 terminates in a plug (not shown) which is concealed within hex nut 21. Hex nut 21 threadably engages threaded section 22 of the housing, and the connection is made therein. In this embodiment, the user must purchase the assembly of cable 13 and hex connector 21, specifying the exact cable length. In other similar prior art embodiments, cable plugs and connectors are attached at each end of the cable. But, again, the entire cable with suitable end-plugs or connectors must be ordered to specified, predetermined lengths. In other words, the user is not free to cut the cable to length on site or in the field. Moreover, these embodiments require a plug at one or both ends of the cable—another burden for the user.

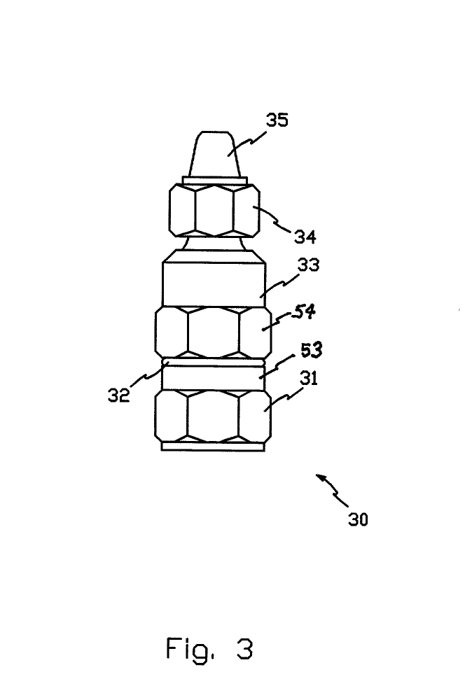

The present invention is illustrated in side view in FIG. 3. Connector assembly 30 comprises lower housing 53, upper housing 33, and sealing nut 34. The upper housing threadably engages the lower housing, and the sealing nut threadably engages the upper housing. The connector optionally includes grommet 35 which fits within the sealing nut.

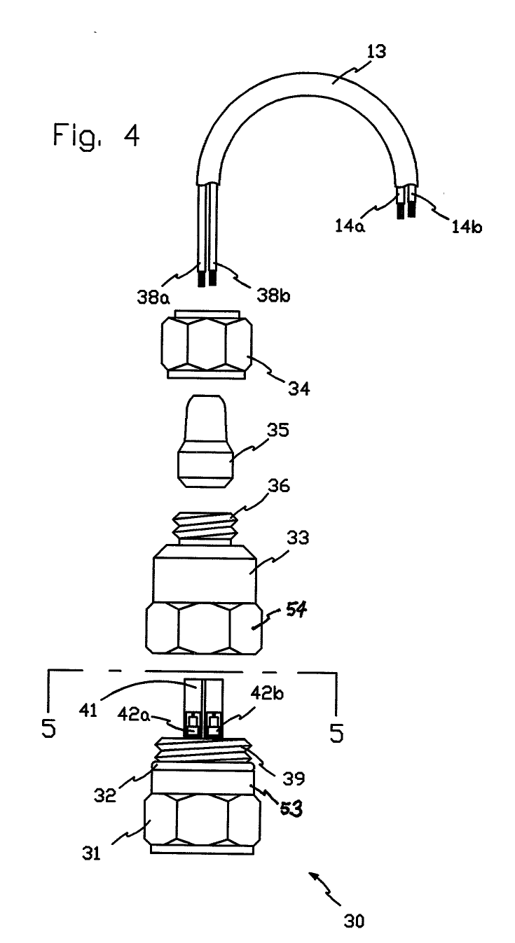

The connector assembly is shown in exploded view in FIG. 4. Lower housing 53 includes base 31 and upper male threaded section 39. The base houses the sensor (not shown), such as a piezoelectric accelerometer. Base 31 is hexagonal in shape to facilitate mounting. The base includes a concentric threaded partial throughbore at its bottom (not shown) for mounting on a threaded rod section. The lower housing also includes terminal block 41, which includes pin connectors 42a and 42b, respectively, for connection of cable leads 38a and 38b, respectively. The terminal block is fixedly secured within threaded section 39 by any suitable means, such as epoxy or other adhesive. Upper housing 33 includes lower female threaded section 54 (the threads are internal and not shown in the drawing), having a hex shaped outer surface to accommodate tightening of the upper housing onto the lower housing. Threaded section 54 of the upper housing is operatively arranged to threadably engage male threaded section 39 of the lower housing. Upper housing 33 also includes upper male threaded section 36. Connector assembly 30 further includes sealing nut 34 which includes internal threads (not shown), operatively arranged to threadably engage male threaded section 36 of the upper housing. Sealing nut 34 is hollow and accommodates optional grommet 35. To make the connection, cable 13 is inserted through the opening in grommet 35 which, in turn, is located inside sealing nut 34. The cable is then inserted through the aperture in upper housing 33, until leads 38a and 38b are connectable to terminal pins 42a and 42b. Once the leads are connected, the upper housing can be threadably tightened to the lower housing, and the sealing nut can be threadably tightened to the upper housing. If desired or necessary, the junction of the cable and grommet can be further sealed with vinyl, epoxy or some other suitable sealant.

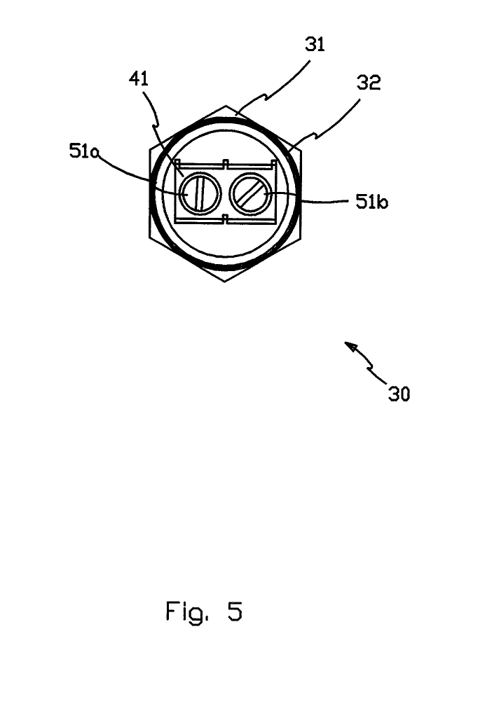

FIG. 5 is a top view of the lower housing, illustrating terminal block 41. This view is taken generally along line 5-5 in FIG. 4. The terminal block is seen to comprise clamping screws 51a and 51b, respectively, which function to secure leads 38a and 38b in terminal pins 42a and 42b, respectively. This view also shows O-ring 32 which functions to form a seal between the upper and lower housing when threadably engaged.

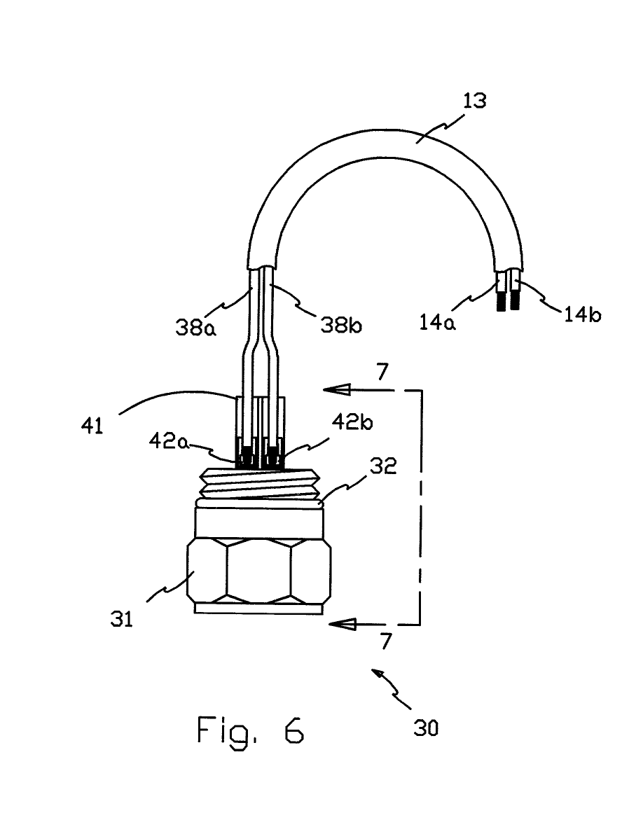

The lower housing is illustrated in FIG. 6 after the cable leads have been connected to the terminal block. For ease in understanding, the upper housing, sealing nut and grommet have been removed from view to show the connection.

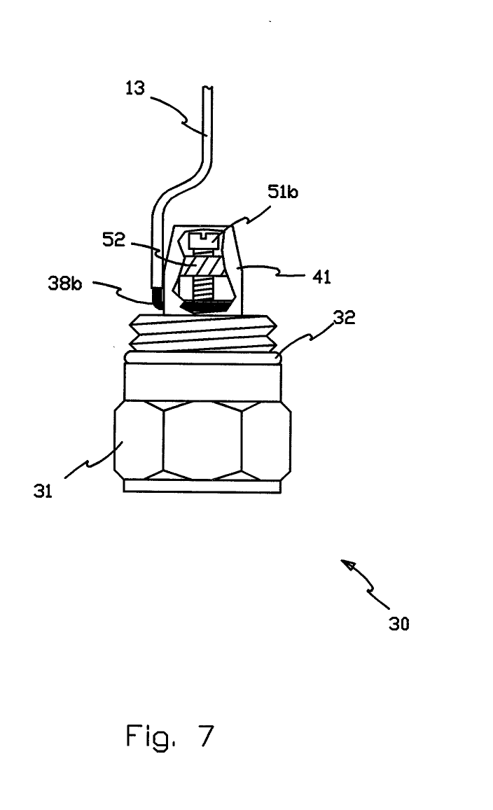

FIG. 7 is yet a further view of the terminal block, taken from the side, generally along line 7-7 of FIG. 6. The terminal block is shown in partial fragmentary view to illustrate screw 51b threaded into terminal block member 52. Lead 38b is seen to enter and be secured by the terminal pin from the left side of terminal block 41.

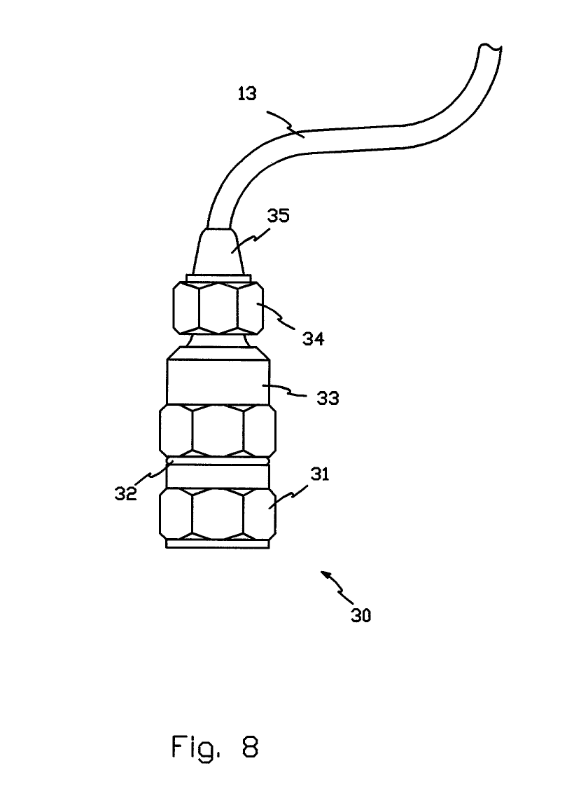

Finally, the completely connected sensor connector assembly is shown in side view in FIG. 8.

It should be apparent to those having ordinary skill in the art that the objects, features and advantages of the present invention are efficiently obtained. For example, it should be obvious that users of the subject sensor connector assembly need no longer order and purchase predetermined length cable/plug assemblies. With the present invention, users can simply maintain an inventory of rolled coaxial cable, which they can cut to length as needed. It should also be apparent to those having ordinary skill in the art that changes and modifications to the connector assembly can be made to accommodate various applications. For example, it should be apparent that a vinyl sleeve can be used to seal the cable to the sealing nut in lieu of the grommet. These and other changes and modifications are intended to be within the scope of the claims.

What we claim is:

1. A sensor connector assembly, comprising:
a lower housing having a base operatively arranged to hold said sensor, and an integral male upper threaded section having a terminal block fixedly secured therein;
an upper housing having a female lower threaded section operatively arranged to threadably engage said integral male upper threaded section of said lower housing, said upper housing also having an integral male upper threaded section having an aperture therein to pass a cable for said sensor; and, a sealing nut having a female threaded section operatively arranged to threadably engage said integral male upper threaded section of said upper housing and also having an aperture therein to pass said cable for said sensor.

2. The sensor connector assembly recited in claim 1 further comprising a grommet located within said sealing nut and operatively arranged to seal said cable within said sealing nut.

3. The sensor connector assembly recited in claim 1 wherein said sensor is an accelerometer.

4. The sensor connector assembly recited in claim 3 wherein said sensor is a piezoelectric accelerometer.

5. The sensor connector assembly recited in claim 1 wherein said terminal block includes two terminal pins.

6. The sensor connector assembly recited in claim 1 further comprising an O-ring circumscribing said integral male upper threaded section of said lower housing and operatively arranged to create a seal when said upper housing threadably engages said lower housing.
